(19) United States
(12) Patent Application Publication
(10) Pub. No.: US 2005/0272448 A1
(43) Pub. Date: Dec. 8, 2005

(54) Caller location identifying system and method in a communication network

(75) Inventors: Luc Phu Tran, Escondido, CA (US); Heung Yeoul Ahn, San Diego, CA (US)

Correspondence Address: JONATHAN Y. KANG. ESQ.;LEE, HONG, DEGERMAN, KANG & SCHMADEKA, 14th Floor, 801 S. Figueroa Street, Los Angeles, CA, 90017-5554, US

(73) Assignee: LG Electronics Inc.

(21) Appl. No.: 10/864,110

(22) Filed: Jun. 8, 2004

(51) Int. Cl. H04Q 7/20

(52) U.S. Cl. 455/456.6; 455/566

(57) ABSTRACT

A method for displaying identifying information on a communication device is provided. The method comprises determining whether call related information may be displayed on a first communication device receiving a call from a second communication device; and displaying location information associated with the second communication device on the first communication device's display.

### BACKGROUND

1. Field of Invention

The present invention relates generally to communication services and, more particularly, to a system and method for displaying location information for a caller using a communication device.

2. Related Art

Communication technology and communication related services continue to grow at a rapid pace. One of the most popular services provided over various communication networks, including mobile communication networks, is caller identification, more commonly referred to as caller ID.

Caller ID services typically are implemented to display the phone number and limited information such as the name of a caller on the receiving device. Caller ID enhances user experience by allowing the user to determine in advance the identity of a caller.

Unfortunately, however, the amount of information provided by the currently available caller ID services is limited to name and phone number of the calling party, only. Systems and methods are desirable that can provide additional information about both the calling and receiving parties on both the dialing and receiving communication devices.

### SUMMARY OF THE INVENTION

A method for displaying identifying information on a mobile device is provided. The method comprises determining whether call related information may be displayed on a first mobile device receiving a call from a second mobile device; and displaying location information associated with the second mobile device on the first mobile device's display. The location information is determined based on a phone number assigned to the second mobile device.

In a preferred embodiment, the location information is determined based on actual physical location of the second mobile device at time when the call was placed. Thus, the location information may comprise location of the second mobile device based on a phone number assigned to the second mobile device, the location of the second mobile device based on a location tracking system, or both.

The location tracking system comprises a global positioning system (GPS). In an alternative embodiment, the location tracking system comprises a mechanism that determines the second mobile device's geographic symmetry with respect to at least one element of communication network in which the second mobile device operates. The at least one element comprises a base station in the communication network. User name information associated with the second mobile device is displayed on the first mobile device's display, when the user name information is not blocked.

In another embodiment, phone number information associated with the second mobile device is displayed on the first mobile device's display, when the phone number information is not blocked. The location information is determined based on a phone number, comprising a plurality of segments. The phone number comprises at least one of first, second, and third segments, based on which at least one of first, second, and third levels of detail associated with the location information are respectively displayed on the first mobile device's display.

The first segment comprises area code information. The second segment comprises prefix information. The third segment comprises line number information. The first level of detail comprises a state name identified according to the first segment. The second level of detail comprises a city name identified according to the second segment. The third level of detail comprises a street address identified according to the third segment.

In yet another embodiment, the phone number further comprises a fourth segment based on which a fourth level of detail associated with the location information is displayed on the first mobile device's display. The fourth segment comprises an international code identifying a country.

In one embodiment, the location information comprises a first location associated with the second mobile device based on a phone number assigned to the second mobile device, and a second location associated with the second mobile device based on a location tracking system, wherein the second location is not displayed, if the second location and the first location are same.

In accordance with a preferred embodiment of the invention, a method for displaying identifying information on a mobile device is provided. The method comprises monitoring a number dialed by a user, using a first mobile device; determining a location associated with the number; and displaying the location on the first mobile device's display. The number comprises a first segment associated with a first level of detail for identifying the location, wherein when the first segment is dialed the first level of detail is displayed.

In a one embodiment, the number further comprises a second segment associated with a second level of detail for identifying the location, wherein when the second segment is dialed the second level of detail is displayed. In another embodiment, the number further comprises a third segment associated with a third level of detail for identifying the location, wherein when the third segment is dialed the third level of detail is displayed. The number may comprise a fourth segment associated with a fourth level of detail for identifying the location, wherein when the third segment is dialed the fourth level of detail is displayed.

The first segment comprises a country code, and the first level of detail for identifying the location comprises a name for a respective country, and of last paragraph the second segment comprises an area code, and the second level of detail for identifying the location comprises a name for a respective area. The respective area comprises name of a state, or name of a city. The third segment comprises a prefix, and the third level of detail for identifying the location comprises a location's name; and the fourth segment comprises a line number, and the fourth level of detail for identifying the location comprises a street address.

These and other embodiments of the present invention will also become readily apparent to those skilled in the art from the following detailed description of the embodiments having reference to the attached figures, the invention not being limited to any particular embodiments disclosed.

### BRIEF DESCRIPTION OF THE DRAWINGS

Embodiments of the present invention are understood by referring to the figures in the attached drawings, as provided below.

FIG. 1 illustrates an exemplary communication environment in accordance with one embodiment of the invention.

FIG. 2 is a flow diagram of a location identifying method over a communication network, in accordance with one embodiment of the invention.

FIG. 3 illustrates exemplary display features of a calling device having a location identifying system, in accordance with one embodiment of the invention.

FIG. 4 is a flow diagram of another location identifying method over a communication network, in accordance with one embodiment of the invention.

FIG. 5 illustrates exemplary display features of a call receiving device having a location identifying system, in accordance with one embodiment of the invention.

Features, elements, and aspects of the invention that are referenced by the same numerals in different figures represent the same, equivalent, or similar features, elements, or aspects, in accordance with one or more embodiments.

### DETAILED DESCRIPTION OF THE PREFERRED EMBODIMENTS

An electronic system and corresponding methods, according to an embodiment of the invention, facilitate and provide a location identifying system and method for a mobile communication device. The system and method of the present invention may be implemented for or embedded in a communication device to allow a user to view the location associated with a dialed number, or alternatively to determine the location from which a call is received.

The terms electronic services, services, and online services are used interchangeably herein. The services provided by the system of this invention, in one embodiment, are provided by a service provider. A service provider is an entity that operates and maintains the computing systems and environment, such as server systems and infrastructure that enable the delivery of information and services to mobile terminals, such as cellular phones. Typically, server architecture comprises components (e.g., hardware, software, and communication lines) that store and offer electronic or online services.

In the following, numerous specific details are set forth to provide a thorough description of various embodiments of the invention. Certain embodiments of the invention may be practiced without these specific details or with some variations in detail. In some instances, features not pertinent to the novelty of the system are described in less detail so as not to obscure other aspects of the invention.

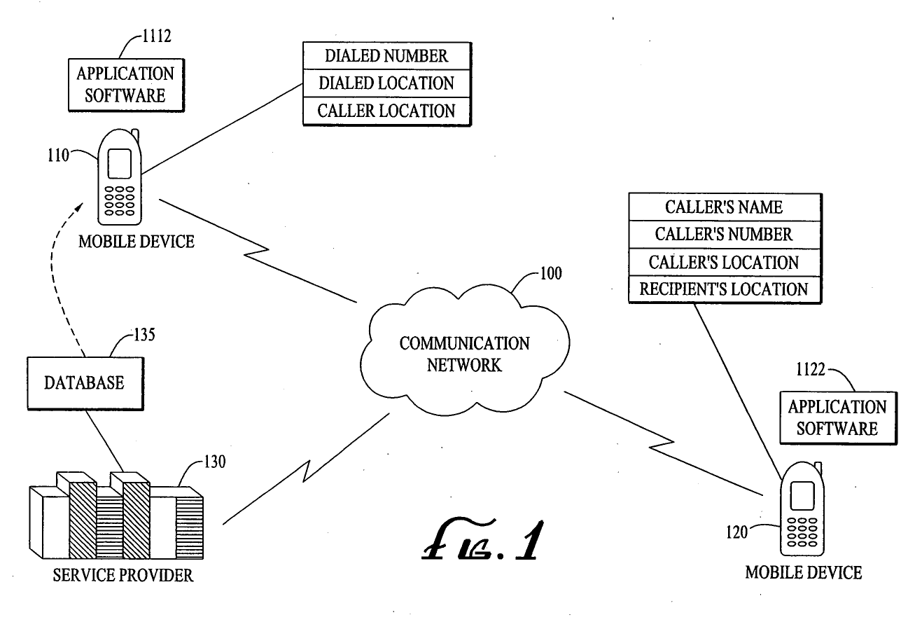

Referring to the drawings, FIG. 1 illustrates an exemplary communication environment in which the system of the present invention may operate. In accordance with one aspect of the system, the environment comprises mobile devices 1 10 and 120 and a service provider 130, each connected to a communication network 100. The terms “connected,” “coupled,” or any variant thereof, mean any connection or coupling, either direct or indirect, wired or wireless, between two or more elements. The coupling or connection between the elements can be physical, logical, or a combination thereof.

In one embodiment, the service provider 130 communicates with the mobile devices 110 and 120 via the communication network 100. The communication network 100 provides the medium for transmitting digital or analog signals between the service provider 130 and the mobile devices 110, 120. In certain embodiments, the mobile devices 1 10, 120 are cellular telephones and communication network 100 is a telephone network, for example.

Mobile devices 110, 120, service provider 130 and communication network 100, however, may be implemented over any type of mobile, fixed, wired or wireless communication system. That is, even though, particular embodiments of the invention have been described herein as applicable to mobile devices, the concept of the invention is equally applicable to any communication device, including a regular telephone.

In one embodiment, the mobile devices 110, 120 may communicate directly or indirectly with one another via wireless service provider 130 or by way of communication network 100, or both. Communication network 100 can be a local area network (LAN), wide area network (WAN), or part of the world wide web (i.e., the Internet). The Internet connects millions of computers world wide through standard common addressing systems and communications protocols (e.g., Transmission Control Protocol/Internet Protocol (TCP/IP), HyperText Transport Protocol), creating a vast communication network.

In either context, the mobile devices 110, 120 can communicate with each other and service provider 130 to send and receive data packets of information, in form of electronic requests and responses. In a particular embodiment, the packets are constructed based on a caller ID service supported by the service provider 130 and implemented over the communication network 100. In one embodiment, service provider 130 is a wireless communications service provider to which a user may subscribe.

As used herein, the terms mobile device, wireless system, service provider and communication network are to be viewed as designations of one or more computing environments that comprise application, client or server software for servicing requests submitted by respective software included in devices or other computing systems connected thereto. These terms are not to be otherwise limiting in any manner. Application software, for example, may be comprised of one or more modules that execute on one or more computing systems, as provided in further detail below.

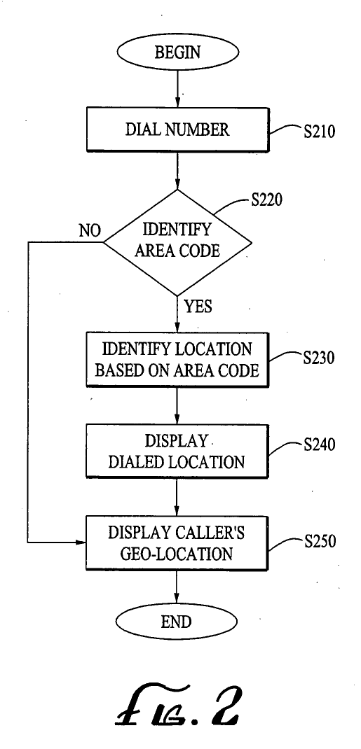

Referring to FIGS. 1 and 2, in accordance with one aspect of the invention, application software 1122 is executed on mobile device 110 and/or mobile device 120 to allow for location identifying system of the present invention to be implemented as an interactive feature. Accordingly, a user may interact with the mobile devices 110, 120 to configure the devices such that when a call is received or dialed, information about the location of a party is displayed.

It should be noted, that the exemplary embodiments disclosed here are not to be construed to limit the scope of the invention to a caller location identification feature or to application software that is exclusively executed on mobile devices 110, 120. In alternative embodiments, application software 1122 may be implemented or executed on a device or system other than mobile devices 110, 120 to provide information including, excluding or in addition to a communicating party's location.

That is, the application software 1122 or its components may be implemented, installed, and executed either in a singular or in a distributed environment to provide additional information about a caller such as a caller's image, personal background data, or other related information, when a call is placed or received. Certain components of the application software 1122 may be installed and executed on mobile device 110, while other components may be executed and installed on mobile device 120, a third party portal, service provider 130, or other systems attached thereto, for example.

Referring to FIG. 2, in accordance with one embodiment, application software 1122 is executed on mobile device 110 when a calling party uses mobile device 110 to dial a number (S210). As the calling party enters the number by interacting with mobile device 110's user interface, application software 1122 parses the digits of the number entered to identify a country code, area code, or other geographically identifying number.

Area codes can be a fixed length (e.g., 3 digits in the United States, or 2 digits in Australia), a variable length (e.g., between 2 and 5 in Germany and South Africa, or between 1 and 3 digits in Japan), or omitted altogether (e.g., France). An exemplary dialed number, in accordance with one embodiment of the invention implemented for the United States, follows the format DXX-DXX-XXXX, where D is any digit from 2 to 9, and X is any digit from 0 to 9.

In the above exemplary embodiment, the first 3 digits represent the area code or numbering plan area (NPA), the second 3 digits represent the central office code or prefix, and the final 4 digits represent the line number. Accordingly, application software 1122 by parsing each of the above-identified segments can identify the area code, the prefix, and the line number of the dialed number.

Referring to FIG. 1, in certain embodiments of the system, at least one of the mobile device 110, service provider 130 or a third party portal (not shown) are connected to a database 135 or a file system, for example. Database 135 or the file system is used to store phone number and identification records that can identify a geographic location covered by a certain area code, prefix or line number. For example, an 858 area code may identify a region in San Diego Calif., and a prefix 262 may further identify a city such as La Jolla. Even further, the line number if associated with a physical line may be traced to a specific address from which the call is made.

Accordingly, when application software 1122 identifies an area code or other segment of the dialed number, then application software 1122 searches the records in database 135 or the file system to identify a geographic location associated with the number. In some embodiments, application software 1122 may be configured to search for different degrees of detail, for example. That is, a user may configure mobile device 1110 to display various information including the state, city, exact address, or all the information associated with the dialed number, as available in database 135 or the related file systems.

Once the particular location is identified, then application software 1122 causes the mobile device 110 to display the related information on mobile device's display (S240). Referring to FIG. 1, for example, the display information may comprise the dialed number, the corresponding dialed location, or both. In one embodiment, the caller's own location may be also displayed. That is, application software 1122 may use the above referenced parsing system to also identify the geographic location associated with the phone number assigned to mobile device 110 (S250).

Accordingly, when the caller is dialing the number, the caller can see that he is making a call from, for example, Los Angeles to San Diego. Advantageously, this will allow the caller to determine if any long distance charges may be applied. One embodiment of the invention is implemented to calculate and show the cost for placing a call between the two displayed locations by accessing a reference schedule of calling rates, for example.

In an alternative embodiment, a global satellite positioning system (GPS) or a positioning service of the communication network 100 may be utilized to determine the actual physical location of mobile device 110 at the time the call is placed. To enable such positioning systems, mobile device 110 may be equipped with a GPS tracking device, for example. In an alternative embodiment, mobile device 110 may be configured to broadcast signals that can be used by the infrastructure implemented in communication network 100 to determine the exact calling location for mobile device 110 based on mobile device 110's geographic symmetry to particular elements (e.g., base stations, antennas, etc.) of communication network 100. Such positioning service may be based on the observed time difference, uplink time difference of arrival, etc.

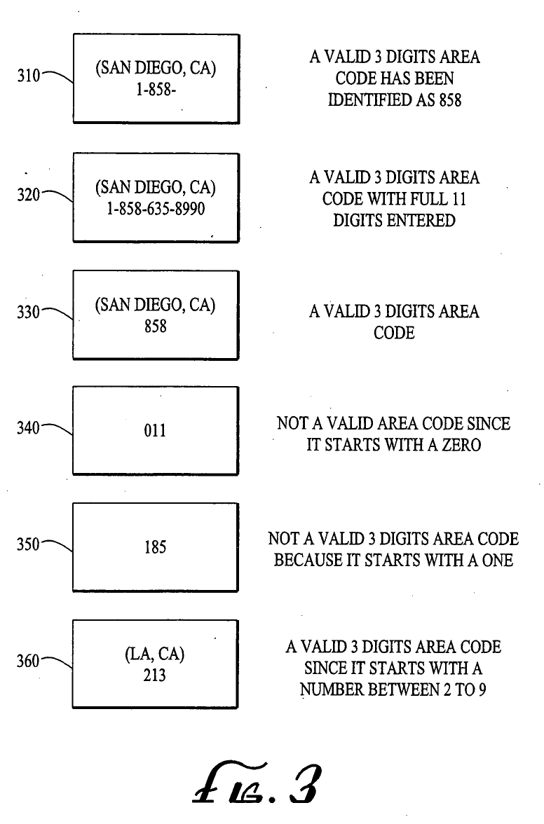

Referring to FIG. 3, block 310 is an exemplary illustration of the content displayed on mobile device 110 when the user has dialed the first 4 digits (i.e., 1-858-) of the number. Since the area code 858 is associated with San Diego, Calif., the respective location is displayed. Blocks 320 and 330 illustrate other exemplary embodiments in dialing states when more or less digits are dialed by the user.

Further, blocks 340 and 350 are illustration of the content that may be displayed on mobile device's 110 display when the dialed digits are not recognized as associated with a valid area code or other geographically identifying series of numbers. Therefore, as shown, no location information is displayed. Block 360 provides yet another exemplary embodiment where the dialed digit sequence “213” is successfully identified as associated with a call placed to Los Angeles Calif.

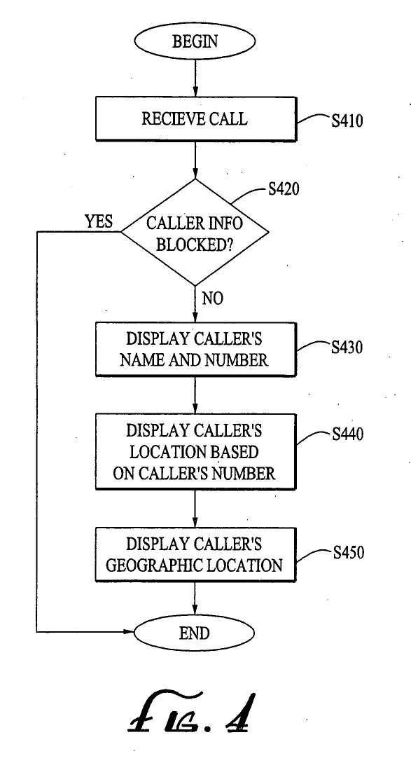

Referring to FIGS. 1, 4 and 5, in accordance with one embodiment of the invention, the application software 1122 may be implemented on mobile device 120 to cause the mobile device 120 to display information about the caller's location, when an incoming call is received by the mobile device 120. As shown, the displayed information depending on implementation may comprise the caller's name, the caller's number, and the location of the caller.

In one embodiment, a caller may choose to block one or more identifying information. For example, the caller may configure mobile device 110 or caller account on service provider 130 to block identifying information about the location from which the caller is calling. Accordingly, when application software 1122 executed on mobile device 120 receives an incoming call (S410) from mobile device 110, for example, then mobile device 120 determines if any of the caller's identification information is blocked.

If there is a complete identification block, then no identifying information will be displayed on mobile device 120. If, however, the blocking procedure is configured to provide at least some identification information, then the permitted identification information is displayed. For example, mobile device 120 in one embodiment displays a caller's name and phone number (S430), the caller's location based on the caller's telephone number (S440), or the caller's geographic location (S450) based on GPS or other identifying information provided by mobile device 110. One or more or a combination of identifying information are displayed, depending on implementation or user configuration.

Advantageously, the ability to configure mobile devices 110 or 120 to provide and display selected identifying information allows the user to protect his or her privacy to a calculated degree. Thus, the user may choose to configure mobile device 110 to provide identifying information related to name, phone number and caller location based on the phone number assigned to mobile device 110. Alternatively, a user may choose to configure mobile device 110 to also provide the geographic location of the caller at the time the call is made, based on a GPS, or network location identifying system embedded in mobile device 110.

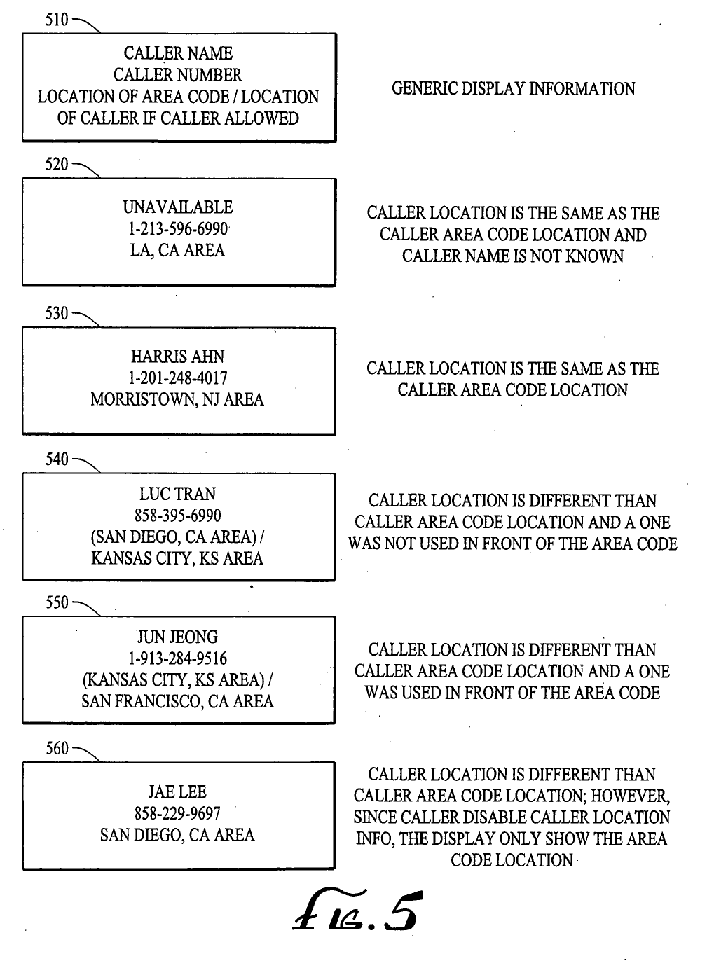

Referring to FIG. 5, various exemplary identifying information displays are illustrated. In accordance with one embodiment, block 510 represents generic display information comprising the caller name, caller number, location of the caller based on area code, and actual geographic location of the caller, if permitted. Block 520 illustrates a scenario in which the caller's actual geographical location (e.g., “LA, Calif. area”) matches the geographic area associated with the caller's telephone number, and where caller has blocked his or her name (e.g., “Unavailable”). Same scenario is illustrated in block 530, where the block against the caller's name is removed, so both the caller's name (e.g., “Harris Ahn”) and location (e.g., “Morristown, N.J. area”) are displayed.

In another embodiment, where the actual calling location is different from the location identified by the mobile device's area code, then both location information are provided. Thus, the exemplary display in block 540, represents a call received from a caller “Luc Tran” calling from a mobile device 110 with an assigned telephone number of “858-395-6990”. “San Diego, Calif. area” is displayed because the 858 area code represents that particular location. “Kansas City, Kans. area” is displayed because the caller is geographically located in that area, when he places the call.

Block 550 illustrates a scenario similar to that illustrated in block 540, where the number 1 is dialed before the area code and the line number are dialed. As such, embodiments of the invention are implemented to distinguish the entry of additional digits from other segments (e.g., area code, prefix, etc.), where the additional digits are not significant in determining the location information for a caller.

Block 560 illustrates mobile device 120's display, in an exemplary embodiment, where a call from “Jae Lee” is received. The caller's phone number (e.g., “858-229-9697”) and location (e.g., “San Diego, Calif.”) is displayed. The actual geographic location of the caller is not displayed, however, because the caller has chosen to block display of such information on the receiving party's telephone, for example.

Embodiments of the invention are described by way of example as applicable to systems and corresponding methods that facilitate display of location information for a caller. As noted earlier, the concept of the invention is applicable to transmission and display of any other type of information, however. In this exemplary embodiment, logic code for performing the identifying functions is implemented in the form of, for example, application software 1122. The logic code, in one embodiment, may be comprised of one or more modules that execute on one or more processors in a distributed or non-distributed communication model.

It should also be understood that the programs, modules, processes, methods, and the like, described herein are but exemplary implementations and are not related, or limited, to any particular computer, apparatus, or computer programming language. Rather, various types of general-purpose computing machines or customized devices may be used with logic code implemented in accordance with the teachings provided, herein. Further, the order in which the methods of the present invention are performed is purely illustrative in nature. These methods can be performed in any order or in parallel, unless indicated otherwise in the present disclosure.

The methods of the present invention may be performed in either hardware, software, or any combination thereof. In particular, some methods may be carried out by software, firmware, or macrocode operating on a computer or computers of any type. Furthermore, such software may be transmitted in the form of a computer signal embodied in a carrier wave, and through communication networks by way of Internet portals or websites, for example. Accordingly, the present invention is not limited to any particular platform, unless specifically stated otherwise in the present disclosure.

The present invention has been described above with reference to preferred embodiments. However, those skilled in the art will recognize that, changes and modifications may be made in these preferred embodiments without departing from the scope of the present invention. Other system architectures, platforms, and implementations that can support various aspects of the invention may be utilized without departing from the essential characteristics as described herein. These and various other adaptations and combinations of features of the embodiments disclosed are within the scope of the invention. The invention is defined by the claims and their full scope of equivalents.

1. A method for displaying identifying information on a mobile device, the method comprising:
determining whether call related information may be displayed on a first mobile device receiving a call from a second mobile device; and
displaying location information associated with the second mobile device on the first mobile device's display.

2. The method of claim 1, wherein the location information is determined based on a phone number assigned to the second mobile device.

3. The method of claim 1, wherein the location information is determined based on actual physical location of the second mobile device at time when the call was placed.

4. The method of claim 1, wherein the location information comprises location of the second mobile device based on a phone number assigned to the second mobile device and location of the second mobile device based on a location tracking system.

5. The method of claim 4, wherein the location tracking system comprises a global positioning system (GPS).

6. The method of claim 4, wherein the location tracking system comprises a mechanism that determines the second mobile device's geographic symmetry with respect to at least one element of communication network in which the second mobile device operates.

7. The method of claim 6, wherein the at least one element comprises a base station in the communication network.

8. The method of claim 1, further comprising:
displaying user name information associated with the second mobile device on the first mobile device's display, when the user name information is not blocked.

9. The method of claim 1, further comprising:
displaying phone number information associated with the second mobile device on the first mobile device's display, when the phone number information is not blocked.

10. The method of claim 1, wherein the location information is determined based on a phone number, comprising a plurality of segments.

11. The method of claim 10, wherein the phone number comprises at least one of first, second, and third segments, based on which at least one of first, second, and third levels of detail associated with the location information are respectively displayed on the first mobile device's display.

12. The method of claim 11, wherein the first segment comprises area code information.

13. The method of claim 11, wherein the second segment comprises prefix information.

14. The method of claim 11, wherein the third segment comprises line number information.

15. The method of claim 11, wherein the first level of detail comprises a state name identified according to the first segment.

16. The method of claim 11, wherein the second level of detail comprises a city name identified according to the second segment.

17. The method of claim 11, wherein the third level of detail comprises a street address identified according to the third segment.

18. The method of claim 11, wherein the phone number further comprises a fourth segment based on which a fourth level of detail associated with the location information is displayed on the first mobile device's display.

19. The method of claim 18, wherein the fourth segment comprises an international code identifying a country.

20. The method of claim 1, wherein the location information comprises a first location associated with the second mobile device based on a phone number assigned to the second mobile device, and a second location associated with the second mobile device based on a location tracking system, wherein the second location is not displayed, if the second location and the first location are same.

21. A method for displaying identifying information on a mobile device, the method comprising:
monitoring a number dialed by a user, using a first mobile device;
determining a location associated with the number; and
displaying the location on the first mobile device's display.

22. The method of claim 21, wherein the number comprises a first segment associated with a first level of detail for identifying the location, wherein when the first segment is dialed the first level of detail is displayed.

23. The method of claim 22, wherein the number further comprises a second segment associated with a second level of detail for identifying the location, wherein when the second segment is dialed the second level of detail is displayed.

24. The method of claim 23, wherein the number further comprises a third segment associated with a third level of detail for identifying the location, wherein when the third segment is dialed the third level of detail is displayed.

25. The method of claim 24, wherein the number further comprises a fourth segment associated with a fourth level of detail for identifying the location, wherein when the third segment is dialed the fourth level of detail is displayed.

26. The method of claim 22, wherein the first segment comprises a country code, and the first level of detail for identifying the location comprises a name for a respective country.

27. The method of claim 23, wherein the second segment comprises an area code, and the second level of detail for identifying the location comprises a name for a respective area.

28. The method of claim 27, wherein the respective area comprises name of a state.

29. The method of claim 27, wherein the respective area comprises name of a city.

30. The method of claim 24, wherein the third segment comprises a prefix, and the third level of detail for identifying the location comprises a location's name.

31. The method of claim 25, wherein the fourth segment comprises a line number, and the fourth level of detail for identifying the location comprises a street address.

32. A method for displaying identifying information on a communication device, the method comprising:
determining whether call related information may be displayed on a first communication device receiving a call from a second communication device; and
displaying location information associated with the second communication device on the first communication device's display, wherein the location information is determined based on a phone number assigned to the second communication device.

33. A method for displaying identifying information on a communication device, the method comprising:
monitoring a number dialed by a user, using a first communication device;
determining a location associated with the number; and
displaying the location on the first communication device's display, wherein the number comprises a first segment associated with a first level of detail for identifying the location, wherein when the first segment is dialed the first level of detail is displayed.

34. A system for displaying identifying information on a communication device, the system comprising:
a processor capable of executing software to determine whether call related information may be displayed on a first communication device receiving a call from a second communication device; and
a display for displaying location information associated with the second communication device on the first communication device's display, wherein the location information is determined based on a phone number assigned to the second communication device.

35. A system for displaying identifying information on a communication device, the system comprising:
a mechanism for monitoring a number dialed by a user;
a processor for determining a location associated with the number; and
a display for displaying the location, wherein the number comprises a first segment associated with a first level of detail for identifying the location, wherein when the first segment is dialed the first level of detail is displayed.
